(19) United States
(12) Patent Application Publication
(10) Pub. No.: US 2013/0126418 A1
(43) Pub. Date: May 23, 2013

(54) LIQUID FILTRATION MEDIA

(71) Applicants: Hyun Sung Lim, Midlothian, VA (US); Robert Anthony Marin, Midlothian, VA (US); Patrick Henry Young, Colonial Heights, VA (US); Guanghui Chen, Glen Allen, VA (US); Timothy Frederick Compton, Midlothian, VA (US); Simon Frisk, Newark, DE (US)

(72) Inventors: Hyun Sung Lim, Midlothian, VA (US); Robert Anthony Marin, Midlothian, VA (US); Patrick Henry Young, Colonial Heights, VA (US); Guanghui Chen, Glen Allen, VA (US); Timothy Frederick Compton, Midlothian, VA (US); Simon Frisk, Newark, DE (US)

(73) Assignee: E. I. DU PONT DE NEMOURS AND COMPANY, Wilmington, DE (US)

(21) Appl. No.: 13/469,431

(22) Filed: May 11, 2012

Related U.S. Application Data
(60) Provisional application No. 61/485,830, filed on May 13, 2011.

(51) Int. Cl. B01D 29/11

(52) U.S. Cl. CPC B01D 29/11
USPC 210/489; 210/483; 210/493.1; 156/167

(57) ABSTRACT

The present invention relates to a liquid filtration medium comprising at least one nonwoven sheet wherein the nonwoven sheet has a water flow rate of at least 10 ml/min/cm²/KPa and a tortuosity filter factor of at least 3.0. The liquid filtration medium can be used in a filter system with an optional pre-filter layer or microfiltration membrane.

### BACKGROUND OF THE INVENTION

1. Field of the Invention

The present invention relates to a liquid filtration medium comprising at least one nonwoven sheet with an improved water flow rate, and an improved tortuosity filter factor. The present invention further relates to a filter system comprising the liquid filtration medium optionally combined with another liquid filtration medium of a pre-filter layer, a microfiltration membrane or both.

2. Description of the Related Art

Membrane filters are broadly used in the area of submicron filtration. They typically offer very high filtration efficiencies, and at a specified level can become absolute. Additionally, some membranes allow for significant fluid flow through their structures, enabling high per unit throughputs.

One drawback of membranes when used in a direct flow through application is that they have very limited filtrate holding capacity. To compensate for this deficiency, separate pre-filters can be used to extend the usable life of the membrane. These additional pre-filters typically are used to separate out items which are at a larger size than the rating of the membrane, allowing the membrane to apply its limited filtrate holding capacity to the tightest size range at which the filtration operation is occurring.

In order for these pre-filters to approach the same general level of filtration size as the membrane, they must be processed so as to close their inherent pore size (e.g. by calendering in the case of typical nonwoven or meltblown materials). This additional processing step typically results in a reduction of the flow rate capability of the pre-filter, frequently reducing it below the flow rate capability of the membrane, resulting in additional pre-filters being required in parallel to accommodate the desired flow rate. Reducing the basis weight and or thickness of the pre-filter to improve its flow rate results in a reduction of its filtrate holding capacity.

It would be desirable to have a pre-filter that could be directly combined with a microporous filtration membrane, that would provide a significant filtration level at the membrane target filtration level without significantly reducing the flow capability of the membrane, and significantly improving the membranes use life by removing a large percentage of the targeted filtrate size and larger items and having significant filtrate holding capacity. In general, it would be desirable to provide a liquid filtration medium useful anyplace in the filtration application, not just as a pre-filter, with improved filtration efficiency, while maintaining a consistently low pressure across its face, a long life expectancy and high tortuosity within the filter medium.

### SUMMARY OF THE INVENTION

In a first embodiment, the present invention relates to a liquid filtration medium comprising at least one nonwoven sheet wherein the nonwoven sheet has a water flow rate of at least 10 ml/min/cm²/KPa and a tortuosity filter factor of at least 3.0. The nonwoven sheet can comprise polymeric fibers that have non-circular cross-sectional shapes, such as, for example, plexifilamentary fiber strands.

In another embodiment, the present invention relates to a filter system for filtering particles from liquid comprising a liquid filtration medium comprising at least one nonwoven sheet wherein the nonwoven sheet has a water flow rate of at least 10 ml/min/cm²/KPa and a tortuosity filter factor of at least 3.0.

In still another embodiment, the present invention relates to a filter system for filtering particles from liquid comprising a composite liquid filtration medium comprising at least one nonwoven sheet and at least one additional liquid filtration medium selected from the group consisting of a pre-filter layer wherein the pre-filter layer is positioned adjacent to and in a face to face relationship with the nonwoven sheet and is positioned upstream of the nonwoven sheet, a microfiltration membrane wherein the microfiltration membrane is positioned adjacent to and in a face to face relationship with the nonwoven sheet and is positioned downstream of the nonwoven sheet and combinations thereof.

### DETAILED DESCRIPTION OF THE INVENTION

### Definition of Terms

The term “polymer” as used herein, generally includes but is not limited to, homopolymers, copolymers (such as for example, block, graft, random and alternating copolymers), terpolymers, etc., and blends and modifications thereof. Furthermore, unless otherwise specifically limited, the term “polymer” shall include all possible geometrical configurations of the material. These configurations include, but are not limited to isotactic, syndiotactic, and random symmetries.

The term “polyolefin” as used herein, is intended to mean any of a series of largely saturated polymeric hydrocarbons composed only of carbon and hydrogen. Typical polyolefins include, but are not limited to, polyethylene, polypropylene, polymethylpentene, and various combinations of the monomers ethylene, propylene, and methylpentene.

The term “polyethylene” as used herein is intended to encompass not only homopolymers of ethylene, but also copolymers wherein at least 85% of the recurring units are ethylene units such as copolymers of ethylene and alpha-olefins. Preferred polyethylenes include low-density polyethylene, linear low-density polyethylene, and linear high-density polyethylene. A preferred linear high-density polyethylene has an upper limit melting range of about 130° C. to 140° C., a density in the range of about 0.941 to 0.980 gram per cubic centimeter, and a melt index (as defined by ASTM D-1238-57T Condition E) of between 0.1 and 100, and preferably less than 4.

The term “polypropylene” as used herein is intended to embrace not only homopolymers of propylene but also copolymers where at least 85% of the recurring units are propylene units. Preferred polypropylene polymers include isotactic polypropylene and syndiotactic polypropylene.

The term “nonwoven sheet” as used herein means a structure of individual fibers or threads that are positioned in a random manner to form a planar material without an identifiable pattern, as in a knitted fabric.

The term “plexifilament” as used herein means a three-dimensional integral network or web of a multitude of thin, ribbon-like, film-fibril elements of random length. Typically, these have a mean film thickness of less than about 4 micrometermicrometers and a median fibril width of less than about 25 micrometers. The average film-fibril cross sectional area if mathematically converted to a circular area would yield an effective diameter between about 1 micrometer and 25 micrometers. In plexifilamentary structures, the film-fibril elements intermittently unite and separate at irregular intervals in various places throughout the length, width and thickness of the structure to form a continuous three-dimensional network.

### DESCRIPTION

In a first embodiment, the present invention relates to a liquid filtration medium comprising at least one nonwoven sheet wherein the nonwoven sheet has a water flow rate of at least 10 ml/min/cm²/KPa and a tortuosity filter factor of at least 3.0.

The nonwoven sheet of the present invention comprises polymeric fibers. The polymeric fibers are made from polymers selected from the group consisting of polyolefins, polyesters, polyamides, polyaramids, polysulfones, fluoropolymers and combinations thereof.

The polymeric fibers can be plexifilamentary fiber strands made according to the flash-spinning process disclosed in U.S. Pat. No. 7,744,989 to Marin et al., which is hereby incorporated by reference, with additional thermal stretching prior to sheet bonding. Preferably, the thermal stretching comprises uniaxially stretching the unbonded web in the machine direction between heated draw rolls at a temperature between about 124° C. and about 154° C., positioned at relatively short distances less than 32 cm apart, preferably between about 5 cm and about 30 cm apart, and stretched between about 3% and 25% to form the stretched web. Stretching at draw roll distances more than 32 cm apart may cause significant necking of the web which would be undesirable. Typical polymers used in the flash-spinning process are polyolefins, such as polyethylene and polypropylene. It is also contemplated that copolymers comprised primarily of ethylene and propylene monomer units, and blends of olefin polymers and copolymers could be flash-spun.

For example, a liquid filtration medium can be produced by a process comprising flash spinning a solution of 12% to 24% by weight polyethylene in a spin agent consisting of a mixture of normal pentane and cyclopentane at a spinning temperature from about 205° C. to 220° C. to form plexifilamentary fiber strands and collecting the plexifilamentary fiber strands into an unbonded web, uniaxially stretching the unbonded web in the machine direction between heated draw rolls at a temperature between about 124° C. and about 154° C., positioned between about 5 cm and about 30 cm apart and stretched between about 3% and 25% to form the stretched web, and bonding the stretched web between heated bonding rolls at a temperature between about 124° C. and about 154° C. to form a nonwoven sheet wherein the nonwoven sheet has a water flow rate of at least 10 ml/min/cm²/KPa and a tortuosity filter factor of at least 3.0.

The nonwoven sheet of the present invention has a water flow rate of at least 10, at least 15 or even at least 20 ml/min/cm²/KPa, and a tortuosity filter factor of at least 3.0 or even at least 3.5. The nonwoven sheet of the present invention demonstrates an improvement in the combination of water flow rate and a tortuosity filter factor over the prior art liquid filtration media.

The nonwoven sheet of the present invention has a filtration efficiency rating of at least 50, at least 60, at least 70 or even at least 80% at a 0.5 micrometer particle size and a life expectancy normalized to the basis weight of the nonwoven sheet of at least 2.9, at least 3.7, at least 4.4 or even at least 5.1 min/g/m².

An advantage of the nonwoven sheet of the present invention is the easy removal of particulates from a slurry of particulates and a liquid.

In another embodiment, the present invention relates to a filter system for filtering particles from liquid comprising a liquid filtration medium comprising at least one nonwoven sheet wherein the nonwoven sheet has a water flow rate of at least 10 ml/min/cm²/KPa and a tortuosity filter factor of at least 3.0.

In still another embodiment, the present invention relates to a filter system for filtering particles from liquid comprising a composite liquid filtration medium comprising at least one nonwoven sheet and at least one additional liquid filtration medium. The additional liquid filtration medium is selected from the group consisting of a pre-filter layer wherein the pre-filter layer is positioned adjacent to and in a face to face relationship with the nonwoven sheet and is positioned upstream of the nonwoven sheet, a microfiltration membrane wherein the microfiltration membrane is positioned adjacent to and in a face to face relationship with the nonwoven sheet and is positioned downstream of the nonwoven sheet and combinations thereof.

The nonwoven sheet and the additional liquid filtration medium can be left in an unbonded state or optionally bonded to each other over at least a fraction of their surfaces. The nonwoven sheet and the microfiltration membrane can be bonded by thermal lamination, point bonding, ultrasonic bonding, adhesive bonding, and any means for bonding known to one skilled in the art.

The microfiltration membrane can comprise, for example, a polymer selected from the group consisting of expanded polytetrafluoroethylene, polysulfone, polyethersulfone, polyvinylidene fluoride, polycarbonate, polyamide, polyacrylonitrile, polyethylene, polypropylene, polyester, cellulose acetate, cellulose nitrate, mixed cellulose ester, and blends and combinations thereof.

The filter system of the invention may further comprise a scrim layer in which the scrim layer is located adjacent to only the nonwoven sheet, the pre-filter layer, the microfiltration membrane, or combinations thereof. A “scrim”, as used here, is a support or drainage layer and can be any planar structure which optionally can be bonded, adhered or laminated to the nonwoven sheet, the pre-filter layer, the microfiltration membrane, or combinations thereof. Advantageously, the scrim layers useful in the present invention are spunbond nonwoven layers, but can be made from carded webs of nonwoven fibers and the like, or even woven nets

The liquid filtration medium can act to provide depth filtration to the microfiltration membrane by pre-filtering larger particles thereby extending the lifetime of the microfiltration membrane.

The filter system can be any equipment or system used to filter a liquid, such as, for example, an automatic pressure filter, a cartridge, a filter bag, a pleated filter bag and a filter sock.

### Test Methods

In the non-limiting Examples that follow, the following test methods were employed to determine various reported characteristics and properties. ASTM refers to the American Society of Testing Materials.

Basis Weight was determined by ASTM D-3776, which is hereby incorporated by reference and report in g/m².

Water Flow Rate was calculated as follows. A closed loop filtration system consisting of a 60 liter high density polyethylene (HDPE) storage tank, Levitronix LLC (Waltham, Mass.) BPS-4 magnetically coupled centrifugal high purity pump system, Malema Engineering Corp. (Boca Raton, Fla.) M-2100-T3104-52-U-005/USC-731 ultrasonic flow sensor/meter, a Millipore (Billerica, Mass.) 90 mm diameter stainless steel flat sheet filter housing (51.8 cm² filter area), pressure sensors located immediately before and after the filter housing and a Process Technology (Mentor, Ohio) TherMax2 IS1.1-2.75-6.25 heat exchanger located in a separate side closed loop.

A 0.1 micrometer filtered deionized (DI) water was added to a sixty liter HDPE storage tank. The Levitronix pump system was used to automatically, based on the feedback signal from the flowmeter, adjust the pump rpm to provide the desired water flow rate to the filter housing. The heat exchanger was utilized to maintain the temperature of the water to approximately 20° C. Prior to water permeability testing, the cleanliness of the filtration system was verified by placing a 0.2 micrometer polycarbonate track etch membrane in the filter housing and setting the Levitronix pump system to a fixed water flow rate of 1000 ml/min. The system was declared to be clean if the delta pressure increased by <0.7 KPa over a 10 minute period. The track etch membrane was removed from the filter housing and replaced with the media for water permeability testing. The media was then wetted with isopropyl alcohol and subsequently flushed with 1-2 liters of 0.1 micrometer filtered DI water. The water permeability was tested by using the Levitronix pump system to increase the water flow rate at 60 ml/min intervals from 0 to 3000 ml/min. The upstream pressure, downstream pressure and exact water flow rate were recorded for each interval. The slope of the pressure vs. flow curve was calculated in ml/min/cm²/KPa, with higher slopes indicating higher water permeability.

Filtration Efficiency measurements were made by test protocol developed by ASTM F795. A 50 ppm ISO test dust solution was prepared by adding 2.9 g of Powder Technology Inc. (Burnsville, Minn.) ISO 12103-1, A3 medium test dust to 57997.1 g 0.1 micrometer filtered DI water in a sixty liter HDPE storage tank. Uniform particle distribution was achieved by mixing the solution for 30 minutes prior to filtration and maintained throughout the filtration by using an IKA Works, Inc. (Wilmington, N.C.) RW 16 Basic mechanical stirrer set at speed nine with a three inch diameter three-blade propeller and also re-circulated with a Levitronix LLC (Waltham, Mass.) BPS-4 magnetically coupled centrifugal high purity pump system. Temperature was controlled to approximately 20° C. using a Process Technology (Mentor, Ohio) TherMax2 IS1.1-2.75-6.25 heat exchanger located in a side closed loop.

Prior to filtration, a 130 ml sample was collected from the tank for subsequent unfiltered particle count analysis. Filtration media was placed in a Millipore (Billerica, Mass.) 90 mm diameter stainless steel flat sheet filter housing (51.8 cm² filter area), wetted with isopropyl alcohol and subsequently flushed with 1-2 liters of 0.1 micrometer filtered DI water prior to starting filtration.

Filtration was done at a flow rate of 200 ml/min utilizing a single pass filtration system with a Malema Engineering Corp. (Boca Raton, Fla.) M-2100-T3104-52-U-005/USC-731 ultrasonic flow sensor/meter and pressure sensors located immediately before and after the filter housing. The Levitronix pump system was used to automatically (based on the feedback signal from the flowmeter) adjust the pump rpm to provide constant flow rate to the filter housing. The heat exchanger was utilized to control the temperature of the liquid to approximately 20° C. in order to remove this variable from the comparative analysis as well as reduce evaporation of water from the solution that could skew the results due to concentration change.

The time, upstream pressure and downstream pressure were recorded and the filter life was recorded as the time required to reach a delta pressure of 69 KPa.

A filtered sample was collected at 2 minutes for subsequent particle count analysis. The unfiltered and filtered samples were measured for particle counts using Particle Measuring Systems Inc. (Boulder, Colo.) Liquilaz SO2 and Liquilaz SO5 liquid optical particle counters. In order to measure the particle counts, the liquids were diluted with 0.1 micrometer filtered DI water to a final unfiltered concentration at the Liquilaz SO5 particle counting sensor of approximately 4000 particle counts/ml. The offline dilution was done by weighing (0.01 g accuracy) 880 g 0.1 micrometer filtered DI water and 120 g 50 ppm ISO test dust into a 1 L bottle and mixing with a stir bar for 15 minutes. The secondary dilution was done online by injecting a ratio of 5 ml of the diluted ISO test dust into 195 ml 0.1 micrometer filtered DI water, mixing with a inline static mixer and immediately measuring the particle counts. Filtration efficiency was calculated at a given particle size from the ratio of the particle concentration passed by the medium to the particle concentration that impinged on the medium within a particle “bin” size using the following formula.

Efficiency_{(α size)}(%)=(Nᵤₚₛₜᵣₑₐₘ−N_{downstream})*100/Nᵤₚₛₜᵣₑₐₘ

Life Expectancy is the time required to reach a terminal pressure at 69 KPa.

Life Expectancy Normalized was calculated by dividing the life expectancy by the basis weight and was reported in min/g/m².

Mean Flow Pore Size was measured according to ASTM Designation E 1294-89, “Standard Test Method for Pore Size Characteristics of Membrane Filters Using Automated Liquid Porosimeter.” with a capillary flow porosimeter (model number CFP-34RTF8A-3-6-L4, Porous Materials, Inc. (PMI), Ithaca, N.Y.). Individual samples of different sizes (8, 20 or 30 mm diameter) were wetted with a low surface tension fluid (1,1,2,3,3,3-hexafluoropropene, or “Galwick,” having a surface tension of 16 dyne/cm) and placed in a holder, and a differential pressure of air is applied and the fluid removed from the samples. The differential pressure at which wet flow is equal to one-half the dry flow (flow without wetting solvent) is used to calculate the mean flow pore size using supplied software.

Nominal Rating 90% Efficiency was measured on a filter media capable of removing a nominal percentage (i.e. 90%) by weight of solid particles of a stated micrometer size (i.e. 90% of 10 micrometer). The micrometer ratings were determined at 90% efficiency at a given particle size.

Tortuosity Filter Factor is a measure of the degree of difficulty for a particle to pass through a porous structure and is calculated by dividing the mean flow pore size by the nominal rating 90% efficiency.

### EXAMPLES

Hereinafter the present invention will be described in more detail in the following examples.

### Examples 1 and 2

Examples 1 and 2 representing nonwoven sheets of the present invention were made from flash spinning technology as disclosed in U.S. Pat. No. 7,744,989, incorporated herein by reference, with additional thermal stretching prior to sheet bonding. Unbonded nonwoven sheets were flash spun from a 20 weight percent concentration of high density polyethylene having a melt index of 0.7 g/10 min (measured according to ASTM D-1238 at 190° C. and 2.16 kg load) in a spin agent of 68 weight percent normal pentane and 32 weight percent cyclopentane. The unbonded nonwoven sheets were stretched and whole surface bonded. The sheets were run between pre-heated rolls at 146° C., two pairs of bond rolls at 146° C., one roll for each side of the sheet, and backup rolls at 146° C. made by formulated rubber that meets Shore A durometer of 85-90, and two chill rolls. Examples 1 and 2 were stretched 6% and 18% between two pre-heated rolls with 10 cm span length at a rate of 30.5 and 76.2 m/min, respectively. The delamination strength of Examples 1 and 2 was 0.73 N/cm and 0.78 N/cm, respectively. The sheets' physical and filtration properties are given in the Table.

### Comparative Example A

Comparative Example A was prepared similarly to Examples 1 and 2, except without the sheet stretching. The unbonded nonwoven sheet was whole surface bonded as disclosed in U.S. Pat. No. 7,744,989. Each side of the sheet was run over a smooth steam roll at 359 kPa steam pressure and at a speed of 91 m/min.

The delamination strength of the sheet was 1.77 N/cm. The sheet's physical and filtration properties are given in the Table. Examples 1 and 2 of the present invention have superior water flow rate as compared to Comparative Example A.

### Comparative Example B

Comparative Example B was Tyvek® SoloFlo® (available from DuPont of Wilmington, Del.), a commercial flash spun nonwoven sheet product for liquid filtration applications such as waste water treatments. The product is rated as a 1 micrometer filter media which has 98% efficiency with 1 micrometer particles. The sheet's physical and filtration properties are given in the Table. Examples 1 and 2 of the present invention have superior water flow rate, life expectancy normalized to the basis weight and tortuosity filter factor as compared to Comparative Example B.

### Comparative Examples C and D

Comparative Examples C and D were Oberlin 713-3000 a polypropylene spunbond/meltblown nonwoven sheet composite and Oberlin 722-1000 a polypropylene spunbond/meltblown/spunbond nonwoven sheet composite (available from Oberlin Filter Co. of Waukesha, Wis.). The sheets' physical and filtration properties are given in the Table. Examples 1 and 2 of the present invention have superior filtration efficiency and tortuosity filter factor as compared to Comparative Examples C and D.

### Comparative Examples E and F

Comparative Examples E and F were meltblown nonwoven sheets made from polypropylene nanofibers. Comparative Examples E and F were made according to the following procedure. A 1200 g/10 min melt water flow rate polypropylene was meltblown using a modular die as described in U.S. Pat. No. 6,114,017. The process conditions that were controlled to produce these samples were the attenuating air water flow rate, air temperature, polymer water flow rate and temperature, die body temperature, die to collector distance. Along with these parameters, the basis weights were varied by changing the changing the collection speed and polymer through put rate. The average fiber diameters of these samples were less than 500 nm. The sheets' physical and filtration properties are given in the Table. Examples 1 and 2 of the present invention have superior filtration efficiency and tortuosity filter factor as compared to Comparative Examples E and F.

### Comparative Examples G-J

Comparative Examples G-J were PolyPro XL disposal filters PPG-120, 250, 500 and 10C which are rated by retention at 1.2, 2.5. 5 and 10 micrometers, respectively (available from Cuno of Meriden, Conn.), a polypropylene calendered meltblown filtration media rated for 1.2, 2.5, 5, and 10 micrometer, respectively. The sheets' physical and filtration properties are given in the Table. Examples 1 and 2 of the present invention have superior water flow rate and tortuosity filter factor as compared to Comparative Examples G-J.

TABLE
Nonwoven Sheet Physical and Filtration Properties

| | | | | | | Mean | Nominal | |
|---|---|---|---|---|---|---|---|---|
| | | | | | Life | Pore | Rating | Tortuosity |
| | Basis | | Filtration | Life | Expectancy | Flow | 90% | Filter |
| Exam- | Weight | Water Flow Rate | Efficiency | Expectancy | Normalized | Size | Efficiency | Factor |
| ple | (g/m²) | (ml/min/cm²/KPa) | (%) | (min) | (min/g/m²) | (μm) | (μm) | (−) |
| 1 | 47.1 | 25.5 | 52.2 | 180.0 | 3.82 | 7.3 | 1.90 | 3.87 |
| 2 | 41.6 | 39.8 | 50.7 | 188.5 | 4.53 | 6.2 | 1.90 | 3.24 |
| A | 51.4 | 7.3 | 74.2 | 195.5 | 3.80 | 5.0 | 1.30 | 3.88 |
| B | 40.3 | 1.8 | 94.3 | 72.0 | 1.79 | 2.8 | 0.35 | 8.00 |
| C | 71.3 | 71.1 | 12.1 | 288.0 | 4.04 | 10.8 | 10.00 | 1.08 |
| D | 48.9 | 140.9 | 14.7 | 192.9 | 3.94 | 12.0 | >10.00 | ~1.0 |
| E | 62.5 | 36.8 | 25.9 | 334.1 | 5.35 | 5.9 | 2.75 | 2.16 |
| F | 51.3 | 41.0 | 44.9 | 313.3 | 6.10 | 7.8 | 3.50 | 2.23 |
| G | 105.4 | 0.7 | 98.0 | 182.0 | 1.73 | 0.8 | 0.33 | 2.34 |
| H | 98.3 | 2.1 | 84.3 | 210.0 | 2.14 | 1.4 | 0.65 | 2.11 |
| I | 98.8 | 4.4 | 58.1 | 242.0 | 2.45 | 1.9 | 1.20 | 1.61 |
| J | 147.2 | 11.2 | 50.0 | 258.9 | 1.76 | 2.4 | 1.35 | 1.76 |

The nonwoven sheet of the present invention demonstrates an improvement in the combination of water flow rate and tortuosity filter factor over the prior art liquid filtration media including spunbond/meltblown sheets, spunbond/meltblown/spunbond sheets, meltblown nanofiber sheets and calendered meltblown sheets.

What is claimed is:

1. A liquid filtration medium comprising at least one nonwoven sheet comprising polymeric fibers wherein the nonwoven sheet has a water flow rate of at least 10 ml/min/cm²/KPa and a tortuosity filter factor of at least 3.0.

2. The liquid filtration medium of claim 1, wherein the polymeric fibers are made from polymers selected from the group consisting of polyolefins, polyesters, polyamides, polyaramids, polysulfones, polyimides, fluorinated polymers and combinations thereof.

3. The liquid filtration medium of claim 1, wherein the polymeric fibers have non-circular cross sections.

4. The liquid filtration medium of claim 1, wherein the polymeric fibers are plexifilamentary fiber strands.

5. The liquid filtration medium of claim 1, wherein the nonwoven sheet is a uniaxially stretched nonwoven sheet in the machine direction.

6. The liquid filtration medium of claim 1, wherein the nonwoven sheet has a filtration efficiency rating of at least 50% at a 0.5 micrometer particle size and a life expectancy normalized to the basis weight of the nonwoven sheet of at least 2.9 min/g/m².

7. A filter system for filtering particles from liquid comprising a liquid filtration medium comprising at least one nonwoven sheet comprising polymeric fibers wherein the nonwoven sheet has a water flow rate of at least 10 ml/min/cm²/KPa and a tortuosity filter factor of at least 3.0.

8. The filter system of claim 7, wherein the polymeric fibers are made from polymers selected from the group consisting of polyolefins, polyesters, polyamides, polyaramids, polysulfones, polyimides, fluorinated polymers and combinations thereof.

9. The filter system of claim 7, wherein the polymeric fibers have non-circular cross sections.

10. The filter system of claim 7, wherein the polymeric fibers are plexifilamentary fiber strands.

11. The filter system of claim 7, wherein the nonwoven sheet is a uniaxially stretched nonwoven sheet in the machine direction.

12. The filter system of claim 7, wherein the nonwoven sheet has a filtration efficiency rating of at least 50% at a 0.5 micrometer particle size and a life expectancy normalized to the basis weight of the nonwoven sheet of at least 2.9 min/g/m².

13. The filter system of claim 7, wherein the filter system further comprises at least one additional liquid filtration medium selected from the group consisting of a pre-filter layer wherein the pre-filter layer is positioned adjacent to and in a face to face relationship with the nonwoven sheet and is positioned upstream of the nonwoven sheet, a microfiltration membrane wherein the microfiltration membrane is positioned adjacent to and in a face to face relationship with the nonwoven sheet and is positioned downstream of the nonwoven sheet and combinations thereof.

14. The filter system of claim 7, wherein the filter system is selected from the group consisting of an automatic pressure filter, a cartridge, a filter bag, a pleated filter bag and a filter sock.

15. A process for producing a liquid filtration medium comprising:
flash spinning a solution of 12% to 24% by weight polyethylene in a spin agent consisting of a mixture of normal pentane and cyclopentane at a spinning temperature from about 205° C. to 220° C. to form plexifilamentary fiber strands and collecting the plexifilamentary fiber strands into an unbonded web;
uniaxially stretching the unbonded web in the machine direction between heated draw rolls at a temperature between about 124° C. and about 154° C., positioned between about 5 cm and about 30 cm apart and stretched between about 3% and 25% to form the stretched web; and
bonding the stretched web between heated bonding rolls at a temperature between about 124° C. and about 154° C. to form a nonwoven sheet wherein the nonwoven sheet has a water flow rate of at least 10 ml/min/cm²/KPa and a tortuosity filter factor of at least 3.0.
